(19) United States
(12) Patent Application Publication
(10) Pub. No.: US 2024/0005425 A1
(43) Pub. Date: Jan. 4, 2024

(54) Smart Device Management Through Property Management Portal

(71) Applicant: Smartz Inc., Champaign, IL (US)

(72) Inventors: Ramesh Babu Kuttuboina, Champaign, IL (US); Kevin Kelin Wan, Champaign, IL (US)

(73) Assignee: Smartz Inc., Champaign, IL (US)

(21) Appl. No.: 17/810,344

(22) Filed: Jul. 1, 2022

(51) Int. Cl. G06Q 50/16

(52) U.S. Cl. CPC G06Q 50/163

(57) ABSTRACT

The present invention disclosed is an all-in-one property management portal/software that enables property managers to manage smart home devices such as thermostats, security cameras, leak detectors, smart locks, lighting, sensors, smart vents, and gate access devices along with general features like rental payments, maintenance tracking, property listing, and financials.

### BACKGROUND OF THE INVENTION

The invention belongs to the PropTech industry, especially related to property management software technology.

Current property management software in the PropTech market focuses more on generic property management features such as rental payments, leasing, move-in/move-out, maintenance tickets, and property listing features. They are not focused on managing devices. Some property management software can integrate with third-party smart home devices, but there is no complete software merger between devices and the property management portal.

There are a growing number of smart electronic devices connecting to the internet. The rapid adaption of these devices by people to make their homes or apartments smarter is growing exponentially every year. It is important to think about how current property management software could be transformed through smart device integration.

### SUMMARY OF THE INVENTION

Multifamily properties can host numerous smart home devices such as leak detectors, security cameras, thermostats, smart lighting, door locks, and more. Currently, property managers use various vendors to manage each device. Property managers typically also use a variety of property management software to manage rental, maintenance, and other property-related issues.

To solve this problem, we have come up with an all-in-one property management software solution where all smart devices are managed from a single portal along with common property management features like rental payments, leasing, maintenance, and more.

### BRIEF DESCRIPTIONS OF THE DRAWINGS

FIG. 1 schematically illustrates an example management portal architecture of the present invention.

FIG. 2 schematically illustrates an example management portal application interface of the present invention.

FIG. 3 schematically illustrates an example management portal device installation workflow of the present invention.

FIG. 4 schematically illustrates an example management portal device control workflow of the present invention.

FIG. 5 schematically illustrates an example management portal device status workflow of the present invention.

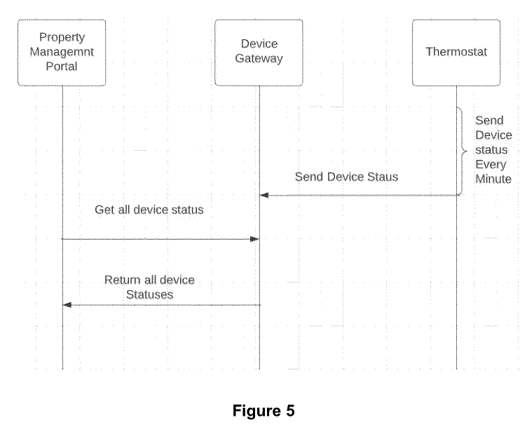

### DETAILED DESCRIPTION

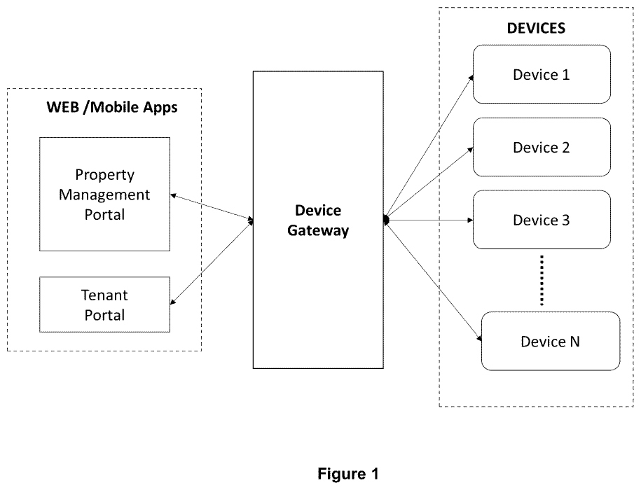

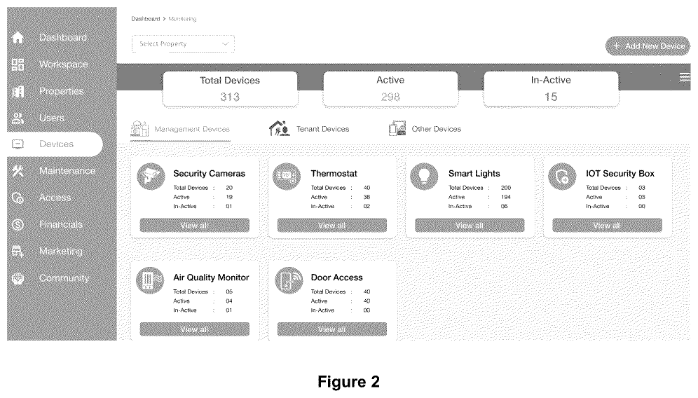

FIG. 1 schematically illustrates an example management portal architecture overview. The architecture overview shows how applications manage and control devices. Management portal applications are device agnostic, and they could be desktop, web, mobile, or tablet-oriented applications. A sample application interface is given in FIG. 2, showing a list of smart devices that are managed from the property management portal.

Any device communication with application portals will pass through the device gateway. The device gateway works as middleware between application portals and devices. It will translate the application communication to the format that the device needs and vice versa.

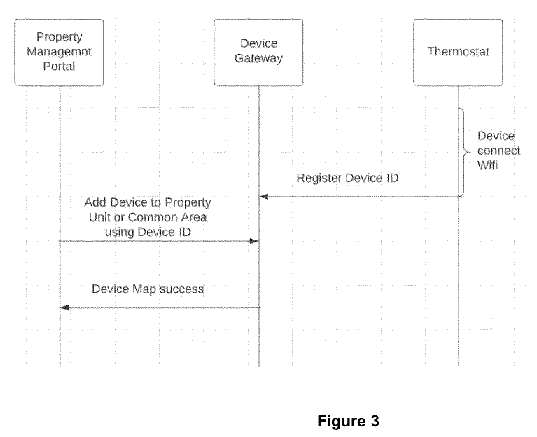

FIG. 3 schematically illustrates an example management portal device installation workflow. Primarily there are 3 types of communication that happen between application portals, device gateways, and devices.

Each smart device contains a unique device ID that first needs to be configured or installed on the device's gateway, after which it can be managed in order to control a device. Whenever a device is added to the network, whether by wireless connection, for example over Wi-Fi, or wired connection, it will communicate with the device gateway to register the device.

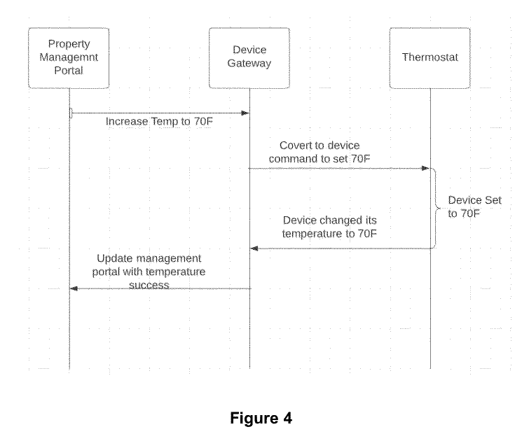

FIG. 4 schematically illustrates an example management portal device control workflow. Control commands can be different for different smart devices. For example, a thermostat is used to increase/decrease the temperature in a space. By comparison, a security camera has a different set of control commands, which can vary and can be anything from live streaming, tilting the camera to view different angles, and more. The device control workflow shall be explained using as an example a smart thermostat, though the invention contemplates the use of other smart devices, such as smart lighting, leak detectors, air quality monitors, etc., and as elaborated herein, and is not limited to smart thermostats.

Whenever a user from either the property management or tenant portal increases or decreases the temperature within that portal, the set temperature command will go from the application portal to the device gateway. This in turn sends the signal to the thermostat device. The device changes the temperature according to the command that was sent and replies with a success status to the device gateway. This is reflected in the management or tenant portal.

Every smart home device frequently communicates to its device gateway, for example every minute, to record its status and whether the device is active or inactive. Any device that doesn't respond for a set period of time, for example for more than 3 minutes, will be considered by the system as inactive. Application portals can send requests to the device gateway for the status of devices using the device ID's, and the device gateway is configured to return the most recent status that was recorded in the device gateway. Further, the system is configured to log information regarding the devices, such as dates and times, commands, status changes, etc.

What is claimed is:

1. A property device control system for controlling devices within a property, comprising:
one or more application portals, a device gateway, and one or more devices.

2. The property device control system of claim 1, wherein the application portal is a property management portal.

3. The property device control system of claim 1, wherein the application portal is a tenant portal.

4. The property device control system of claim 1, wherein the one or more devices comprise smart thermostats.

5. The property device control system of claim 4, wherein the smart thermostats are configured to connect to the device gateway and the smart thermostats are further configured to be controlled by inputs entered into one or more of the application portals and transmitted to the smart thermostats via the device gateway.

6. The property device control system of claim 5, wherein the smart thermostats are further configured to send status information to the device gateway, the device gateway being further configured to send such status information on to one or more of the application portals.

7. The property device control system of claim 1, wherein the one or more devices comprise security cameras.

8. The property device control system of claim 7, wherein the security cameras are configured to connect to the device gateway and the security cameras are further configured to be controlled by inputs entered into one or more of the application portals and transmitted to the security cameras via the device gateway.

9. The property device control system of claim 8, wherein the security cameras are further configured to send status information to the device gateway, the device gateway being further configured to send such status information on to one or more of the application portals.

10. The property device control system of claim 1, wherein the device gateway is configurable to interface between the one or more application portals and the one or more devices.

11. A property device control system for controlling devices within a property, comprising:
one or more devices;
a property management portal, configurable to add the one or more devices to be managed by the property management portal;
a tenant portal;
a device gateway, wherein the one or more devices are configurable to connect to the device gateway and the device gateway is configurable to interface between the property management portal, tenant portal, and the one or more devices, and wherein the device gateway is further configurable to transmit commands, status information and requests back and forth between the property management portal, the tenant portal, and the one or more devices.

12. The property device control system of claim 11, wherein the one or more devices comprise smart thermostats.

13. The property device control system of claim 12, wherein the one or more devices further comprise security cameras.

14. The property device control system of claim 13, wherein the one or more devices further comprise smart lighting.

15. The property device control system of claim 14, wherein the one or more devices further comprise air quality monitors.

16. The property device control system of claim 15, wherein the one or more devices further comprise leak detectors.

17. A method of controlling devices within a property, comprising the steps of:
connecting one or more devices to a device gateway;
adding the one or more devices to a property management portal, such that the one or more devices can be managed by the property management portal;
inputting a management command for one or more of the devices into the property management portal;
such management command being transmitted from the property management portal to the device gateway;
the device gateway converting the management command into a form usable by the one or more devices, and transmitting such management command to the one or more devices;
the one or more devices taking appropriate action based on the management command from the device gateway;
the one or more devices sending a status update to the device gateway;
the device gateway sending the status update from the one or more devices to the property management portal.

18. The method of claim 17, further the comprising the steps of:
the one or more devices periodically sending status updates to the device gateway for transmission on to the property management portal, wherein the status updates comprise information relating to the operating status of the one or more devices and the active or inactive status of the devices, and the property management portal being configurable to request such status updates from the one or more devices; and
the device gateway marking one or more devices as inactive should they fail to provide a status update within a set period of time.

19. The method of claim 18, wherein the one or more devices comprise smart thermostats.

20. The method of claim 19, wherein the one or more devices further comprise security cameras.
